(19) United States
(12) Patent Application Publication
(10) Pub. No.: US 2014/0144763 A1
(43) Pub. Date: May 29, 2014

(54) Power Disconnect Switch

(71) Applicants: Jonathan Willard Justice, Welch, WV (US); Jolene Anne Justice, Welch, WV (US)

(72) Inventors: Jonathan Willard Justice, Welch, WV (US); Jolene Anne Justice, Welch, WV (US)

(21) Appl. No.: 13/687,805

(22) Filed: Nov. 28, 2012

(51) Int. Cl. H01H 3/16

(52) U.S. Cl. CPC H01H 3/161
USPC 200/5 B

(57) ABSTRACT

The present invention is a mechanical device used in the mining industry. The switching device is attached to air lock doors preventing air-changes in mines thus providing a safer work environment for miners. The power disconnect switch provides for a long felt need in the mining industry to provide fresh, breathable air to any person working in mines. The switching device is attached to air lock doors preventing air-changes in mines thus providing a safer work environment for miners. This power disconnect switching device is attached to air lock doors and thus prevents air-changes in mines further, providing a safer work environment for miners.

We are claiming the filing date of Nov. 28, 2011 of Provisional application No. 61/629,813

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of mechanical switches. More particularly, the present invention is in the technical field of mechanical power disconnect switches.

The power disconnect switch provides for a long felt need in the mining industry to provide fresh, breathable air to any person working in mines. The switching device is attached to air lock doors preventing air-changes in mines thus providing a safer work environment for miners. This power disconnect switching device is attached to air lock doors and thus prevents air-changes in mines further, providing a safer work environment for miners.

The purpose of the invention is as follows below. In mines there are 2 air lock doors. When both air lock doors in the mine are opened at the same time, it causes an air change. The air change causes the free flowing, breathable air to escape from the area. This is a violation according to regulations set in place by the Miners Safety Health Association. If this air change occurs, it will substantially lessen breathable air and it will cause an elevation of built up methane gases. The build up of methane gases could also result in explosions of the mine.

By installing the switches, air changes at the air locked doors can be prevented, thereby providing a safer work environment and saving the company both human lives and money.

### SUMMARY OF THE INVENTION

The present invention is a mechanical device used in the mining industry. The switching device is attached to air lock doors preventing air-changes in mines thus providing a safer work environment for miners. The power disconnect switch is comprised of: two solid metal pieces, a plunger made of solid metal and surrounded by a spring which returns the plunger to the upright position when the door is raised, bushing that provides a smooth surface for the plunger to slide through when raising and lowering occurs, a swinging arm, made of high-grade polymer plastic which is attached to the plunger and the lower half of the swinging arm by cotter pins, a second swinging arm placed next to the other swinging arm and is attached to the top half with a cotter pin, a wiring connector, a clevis fastener which is comprised of a clevis, clevis pin and tang, and a pin which are mounted in place by a fiberglass insulator, fiberglass insulators, four copper prongs, which are placed close together in groups of 2 and are mounted onto fiberglass insulators, a ground, a wiring connector where the incoming power is connected, wiring connector located on the copper prongs which connects to the outgoing power, and packing glands and housing for the switch comprised of heavy grade metal.

### BRIEF DESCRIPTION OF THE DRAWING

FIG. 1 is a side view of the present invention.

### DETAILED DESCRIPTION OF THE INVENTION

This is a plunger type switch, here on in switch. Two switches are required to operate the doors; one switch on each door in the mine. The housing for the switch, here on in the box, will be constructed of heavy grade metal approximately ¼ of an inch thick. The box containing the wiring should be buried leaving only the switch itself revealed above ground. The doors on a mine open from the ground up. Therefore, if one of the two doors is closed, the other will operate freely preventing both doors from being opened at the same time.

This power disconnect switching device is attached to air lock doors preventing air-changes in mines thus providing a safer work environment for miners. The power disconnect switch comprised of: two solid metal pieces, a plunger made of solid metal and surrounded by a spring which returns the plunger to the upright position when the door is raised, bushing that provides a smooth surface for the plunger to slide through when raising and lowering occurs, a swinging arm, made of high-grade polymer plastic which is attached to the plunger and the lower half of the swinging arm by cotter pins, a second swinging arm placed next to the other swinging arm and is attached to the top half with a cotter pin, a wiring connector, a clevis fastener which is comprised of a clevis, clevis pin and tang, and a pin which are mounted in place by a fiberglass insulator, fiberglass insulators, four copper prongs, which are placed close together in groups of 2 and are mounted onto fiberglass insulators, a ground, a wiring connector where the incoming power is connected, wiring connector located on the copper prongs which connects to the outgoing power, and packing glands and housing for the switch comprised of heavy grade metal.

For example, when one door (door 1) is closed, it is holding the switch down allowing the power circuit to complete providing power for the other door (door 2) to open. When door 2 is raised or opened, it breaks the power circuit, preventing door 1 from being opened until door 2 is once again closed. The spring used on the top of the box should be able to withstand approximately 100 pounds of pressure to ensure the longevity of the spring. The switch will need to be made of layers of conductive material so that when the switch is up, the materials on the inside, which complete the circuit, do not line up. When the switch is down and the door is closed, the materials inside, conductive and nonconductive, are lined up accordingly, providing power to the other door.

Located on the inside of the housing, fasteners such as the Clevis Fastener will operate the swing arms. In a side view of the inner workings of the switch only one arm can be seen. If one could see the diagram as a 3-D model, one could visibly note that there are in fact two of these swing arms operating simultaneously. They are, in fact, performing the same job, however, one side has a negative charge and the other operates in conjunction with a positive charge. These two arms must remain separate, yet together at all times, not touching one to the other in order to prevent a “phase to phase” or short circuit from occurring.

The fasteners should be mounted separately to the lower inside surface of the “housing” using a non-conductive material such as a fiberglass or hard cased rubber insulator. The benefit of using fiberglass over another insulator such as hard cased rubber is that while the fiberglass is only slightly easier to work with, it proves to be more cost effective.

### DETAILED DESCRIPTION OF THE DRAWING

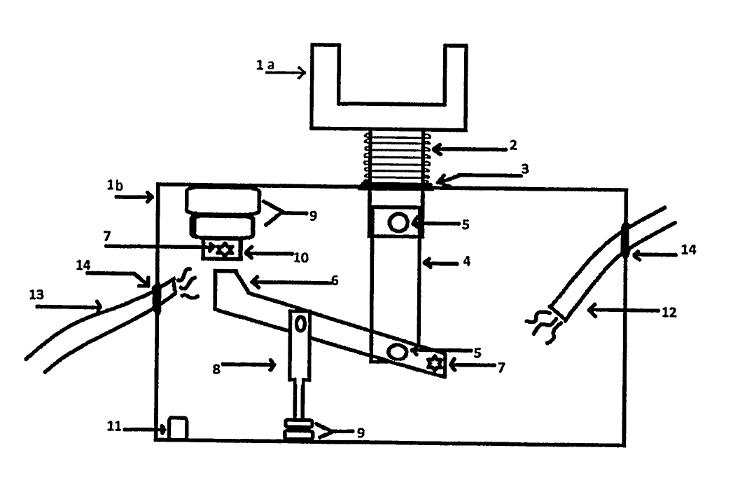

FIG. 1, parts 1a and 1b are solid metal able to withstand heavy weight and pressure such as steel. 1a should be large enough to “hold” the door. Both 1a and 1b should be approximately ¼ inch thick. Part 2 is the lower portion of the plunger. It should be approximately 1 inch in diameter made of solid metal (steel) and surrounded by a spring to aid in returning the plunger to the upright position when the door is raised. Part 3 is bushing. The bushing provides a smooth surface for the plunger (part 2) to slide through when raising and lowering. Part 4 is the top half (1 of 2) of the swinging arm, which is made of high-grade polymer plastic. This part only provides movement; it does not bear weight. Attached to the plunger 2 and the lower half of the swinging arm (part 6) by cotter pins. Part 5 is a cotter pin. Part 6 is a swinging arm (1 of 2 placed side by side) attached to the top half (part 4) with a cotter pin (part 5). This part is made of copper. When the plunger (part 2) is pushed downward, the cotter pins allow the arm (part 6) to move upward and make contact completing the circuit. Part 7 is the wiring connector. This is where incoming wires attach. It provides power to complete the circuit when pressure is applied to the plunger, forcing the arm upward. Part 8 is the clevis fastener and pin (1 of 2), which are mounted in place by a fiberglass insulator (1 of 2) and aid in stabilizing the swing arm while in motion. A clevis fastener is used to attach a bar and chain. A clevis fastener is a three-piece fastener system consisting of a clevis, clevis pin and tang. The clevis is a U-shaped piece that has holes at the end of the prongs to accept the clevis pin. The clevis pin is similar to a bolt, but is only partially threaded or unthreaded with a cross-hole for a cotter pin. The tang is the piece that fits between the clevis and is held in place by the clevis pin. Part 9 are the fiberglass insulators (1 of 2 placed side by side). Part 10 is copper prongs. There are 4 in total and they are placed close together in groups of 2 and are mounted onto fiberglass insulators (part 9). When the swing arms move upward, each side will slide between 2 of the copper prongs making contact and completing the power circuit. Part 11 is the Ground. Part 12 is where the incoming power connects to the wiring connector (part 7). Part 13 is the outgoing power. This connects to the wiring connector located on the copper prongs. Part 14 is packing glands. These prevent wires from sliding out or further in.

1. We are claiming a power disconnect switch comprised of:
two solid metal pieces;
a plunger made of solid metal and surrounded by a spring, which returns the plunger to the upright position when the door is raised;
bushing that provides a smooth surface for the plunger to slide through when raising and lowering occurs;
a swinging arm, made of high-grade polymer plastic, which is attached to the plunger and the lower half of the swinging arm by cotter pins;
a second swinging arm placed next to the other swinging arm and is attached to the top half with a cotter pin;
a wiring connector;
a clevis fastener, which is comprised of a clevis, clevis pin and tang, and a pin, which are mounted in place by a fiberglass insulator;
fiberglass insulators;
four copper prongs, which are placed close together in groups of 2 and are mounted onto fiberglass insulators
a ground;
a wiring connector where the incoming power is connected;
wiring connector located on the copper prongs, which connects to the outgoing power;
packing glands; and
housing for the switch comprised of heavy grade metal.

2. The power disconnect switch of claim 1, further, functioning in the following manner: if door 1 is closed, it is holding the power disconnect switch down allowing the power circuit to complete providing power for door 2 to open; if door 2 is raised or opened, it breaks the power circuit, preventing door 1 from being opened until door 2 is once again closed.

3. The power disconnect switch of claim 1, further, said spring used on the top of the box should be able to withstand at least 100 pounds of pressure.

4. The disconnect switch of claim 1, further, said switch is comprised of layers of conductive material so that when the switch is up, the materials on the inside, which complete the circuit, do not line up and when the switch is down and the door is closed, the materials inside, conductive and nonconductive, are lined up accordingly, providing power to the other door.

5. The disconnect switch of claim 1, further, said fasteners will operate the swing arms.

6. The disconnect switch of claim 1, further, said swing arms: will operate simultaneously; will each have a separate charge: one will have a negative charge and one will have a positive charge; and will remain separate, yet together at all times, not touching one to the other in order to prevent a short circuit from occurring.

7. The disconnect switch of claim 1, further, said fasteners should be mounted separately to the lower inside surface of the housing and should be mounted using a non-conductive material.
